(19) United States
(12) Patent Application Publication
(10) Pub. No.: US 2003/0142597 A1
(43) Pub. Date: Jul. 31, 2003

(54) Micro-integrated near-field optical recording head and optical recording system using the same

(76) Inventors: Kang-Ho Park, Daejon (KR); Ki-Bong Song, Daejon (KR); Sung-Q Lee, Deajon (KR); Jeong-Yong Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/192,976

(22) Filed: Jul. 9, 2002

(30) Foreign Application Priority Data
Jan. 26, 2002 (KR) 2002-4628

(51) Int. Cl. G11B 7/095; G11B 7/135

(52) U.S. Cl. 369/44.23; 369/112.27

(57) ABSTRACT

A micro-integrated probe type head and an optical recording system using the same for recording/reading-out high-density optical information in a near field recording (NFR) manner are provided. The provided micro-integrated probe type head and the optical recording system using the same use a concept of a head that records/reproduces the information by focusing a beam to a probe through a wave guide, a microlens, and a micro-mirror, and by detecting a reflected beam. In this case, the probe is formed by a silicon process to have an aperture with a size of tens of nanometers. By driving the head in a disk actuation structure, high-density near-field optical information having a recording size of 50 to 100 nm is recorded/reproduced at a high speed in a manner of possibly using a conventional tracking technology of an optical disk drive (ODD) or a hard disk drive (HDD).

### BACKGROUND OF THE INVENTION

1. Field of the Invention

The present invention relates to a near-field optical recording (NFR) technology, and more particularly, to a head for realizing NFR in an aperture manner and an optical recording system using the same.

2. Description of the Related Art

An optical recording technology, which records and reads information on and from an optical disk by using a focused laser beam, attracts attention as a digital information storage technology with high-density and large capacity. However, since the diameter of a minimum spot of a light source is limited to about a half of a wavelength by a diffraction limit in a conventional optical system, increasing a recording density is limited.

In order to overcome a diffraction limit, a method for increasing a diffraction radius by increasing the numerical aperture of a lens or a method for reducing the diameter of a beam spot by reducing a conventional wavelength of 600 nm to a wavelength of 400 nm via a blue laser beam is used. However, a limit in the recording density remains by a physical diffraction limit. Accordingly, a new optical recording technology is required.

In particular, an NFR technology has been actively researched. An NFR technology is based on a principle that when the hole is smaller than wavelength of the laser beam, a laser beam passed through the hole within a distance similar to the size of the hole does not generate diffraction. To practice the principle, an optical output unit and an optical detection unit smaller than the wavelength of the laser beam are formed. The beam radiated to the optical output unit is not transmitted to outside of the optical output unit, thereby forming an evanescent wave around the optical output unit for a distance of tens of nanometers. When the evanescent wave approaches to a recording medium for a distance of the wavelength of the laser beam, information can be written or read by the unit smaller than the wavelength of the laser beam. Consequently, an NFR system according to the NFR technology attains a remarkably high recording density like 50 to 100 Gbit/in².

The NFR is divided into an aperture method, a solid immersion lens (SIL) method, and a super resolution near-field structure (RENS) method according to the method for forming near-fields. The aperture method performs recording/readout by scanning a beam from a location adjacent to the surface of a medium by using a very fine probe in which a small aperture is formed for generating a near-field beam. The aperture method may attain a highest recording density among the NFR methods so that high density recording of Tbyte size is possible.

In an early stage of an aperture method research, an optical recording technology using an optical fiber probe is developed. In this case, a tip is formed at an end of the optical fiber to form an aperture of nanometer size, thereby forming a spot smaller than a diffraction limit. However, since the optical fiber probe has a weak mechanical strength and a low near-field throughput, a recording speed is limited and multiplication is impossible. Consequently, a technology for increasing the near-field throughput and mechanical strength by forming an aperture probe at a cantilever has been researched, nowadays.

More specifically, U.S. Pat. No. 5,517,280 discloses a technology for improving the speed of a photolithography having a light resolution of less than a wavelength by using a plurality of optical cantilevers having an optical waveguide. In this case, the optical waveguide and an aperture probe are integrated in the cantilever to focus a beam through the aperture probe. Then, the cantilevers are vibrated on a sample in a vertical direction by capacitive electrodes on the cantilevers and Van der Waals force is detected so that a gap between the aperture probe and the sample is controlled. Accordingly, the lithography operation of nano size can be multiplied by arranging a plurality of cantilever type aperture probes and exposing a photoresist. However, a process for directly integrating an optical waveguide on a cantilever is difficult, and an optical transmittance from an optical waveguide to an aperture probe is low, so that it is difficult to put the technology to practical use. Moreover, a detailed technology for producing a large size scanner of a flat type cantilever is not disclosed.

U.S. Pat. No. 6,101,165 discloses a technology for reading information by using a difference in transmittances of beams, which are radiated while a matrix type planar aperture probe array scans a disk type medium. In this case, a contact slide pad forcibly adjusts a gap between an aperture probe and a medium while the matrix type planar aperture probe array reads information in a multiplex manner. However, since the matrix is formed in a two-dimensional manner, tracking, i.e., precise reading of information recorded on tracks, which are the arranged direction of data marks having information on a recording medium, is complicated. Moreover, since the information is read by contacting a probe on a medium, the probe and the medium are damaged and heat is generated by friction between the probe and the medium. In the case of using a planar head, a bent medium causes an error.

U.S. Pat. No. 6,304,527 discloses a structure for recording/reading-out near-field optical information at a high speed by rotating a single aperture probe, which is formed in a slider, in a contact or flying manner like in the case of a hard disk. Here, an optical radiation and detection structure using a conventional optical disk type optical design structure can be added to a single probe type head. Since the invention uses a single probe, recording/readout speeds are decreased so that a data transfer rate is lowered in an entire information storing system.

As described above, the conventional technologies have problems in the structure of probes, the optical structure for radiating and detecting a beam, and the driving/control methods for rapidly and stably connecting information. Accordingly, it is seriously required to improve the technology in a practical aspect.

### SUMMARY OF THE INVENTION

To solve the above-described problems, it is an objective of the present invention to provide a micro-integrated near-field optical recording (NFR) head with improved structure of an aperture probe, improved optical structure for radiating/detecting a beam, and improved driving/control methods for stably and rapidly connecting information, and an optical recording system using the same.

To accomplish the objective of the present invention, a micro-integrated near-field optical recording head comprises: a micro-optical unit including an optical waveguide, a microlens, and a micro-mirror; a cantilever installed under the micro-optical unit; an aperture probe having a size of less than 100 nm, which is formed on the bottom of the cantilever in a protruding manner; and a gap control structure for maintaining a gap between the aperture probe and a medium for a beam input through the micro-optical unit to record/readout information on/from the medium by using a near-field beam having a resolution of less than 100 nm while passing through the aperture probe.

Here, the gap control structure may include a piezoelectric actuator formed on the bottom of the cantilever while including a ferroelectric thin film for vibrating the cantilever, and a piezoresistive thin film formed on the top surface of the cantilever to detect the changes in the frequency or the vibration deflection by detecting a potential induced from the vibration of the cantilever.

Alternatively, the gap control structure may include a contact probe formed on the bottom of the cantilever toward the outside of the aperture probe, and a piezoresistive thin film formed on the top surface of the cantilever to maintain a gap between the aperture probe and the medium by detecting contact force between the medium and aperture probe, thereby forcibly controlling the gap between the aperture probe and the medium.

Alternatively, the gap control structure may be contact suspension sliding pads formed on the bottom of the cantilever toward the outside of the aperture probe, thereby forcibly controlling the gap between the aperture and the medium.

To accomplish the above objective of the present invention, a micro-integrated near-field optical recording head comprising the above-described micro-integrated near-field optical recording heads manufactured in a one-dimensional array type, which are arranged in a diameter direction of a medium, so as to realize a structure in which a plurality of probes simultaneously record/readout information on/from a plurality of tracks.

A micro-integrated near-field optical recording system using the micro-integrated near-field optical recording head includes: a bimorph type Z-axis fine vertical actuator coupled with the head; an XY-axis fine horizontal actuator of fine tracking coupled with the bimorph type actuator; and an objective lens of an optical disk connected to the XY-axis fine horizontal actuator of fine tracking by a holder, wherein a beam focused on the objective lens coarsely approaches a medium by a voice coil motor (VCM) that moves the objective lens, and the head finely approaches the surface of the medium by the bimorph type actuator and the gap control structure.

In this case, the micro-integrated near-field optical recording system further divides one groove into tracks while tracking between the grooves through the objective lens to record/readout information while tilt controlled by the gap control structure.

When a micro-integrated near-field optical recording system includes a head having contact suspension sliding pads formed under the cantilever in an external direction of the aperture probe, as a gap control structure, a flexible suspension supporter of applying pressure for the head to contact with the medium, and horizontal and vertical fine actuators for controlling horizontal location and tilt of the head are further included.

According to the present invention, the head is driven in a disk driving structure. Consequently, it is possible to record/readout near-field optical information at a high density such as a recording size of 50 to 100 nm and at a high speed while possibly using a tracking technology of a conventional optical disk drive (ODD) or hard disk drive (HDD).

### BRIEF DESCRIPTION OF THE DRAWINGS

The above objective and advantages of the present invention will become more apparent by describing in detail preferred embodiments thereof with reference to the attached drawings in which:

FIG. 1 is a side view of a micro-integrated near-field optical recording head according to an embodiment of the present invention;

FIG. 2 is an enlarged perspective view illustrating a cantilever portion included in the head shown in FIG. 1;

FIG. 3 is a side view of an optical recording system using a multi-cantilever micro-integrated near-field optical head according to a second embodiment of the present invention;

FIG. 4 is a plan view of the optical recording system shown in FIG. 3;

FIG. 5 is a view for explaining a dual mode tracking principle of the head shown in FIG. 3;

FIG. 6 is a side view of a micro-integrated near-field optical recording head according to a third embodiment of the present invention;

FIG. 7 is a side view of a contact slider micro-integrated near-field optical recording head according to a fourth embodiment of the present invention; and

FIG. 8 is a view for explaining a tracking principle using tilt of the head shown in FIG. 7.

### DETAILED DESCRIPTION OF THE INVENTION

Preferred embodiments of the present invention will now be described with reference to the accompanying drawings. This invention may, however, be embodied in many different forms and should not be construed as being limited to the embodiments set forth herein; rather, these embodiments are provided so that this disclosure will be thorough and compete, and will fully convey the concept of the invention to those skilled in the art. The same reference numerals in different drawings represent the same element. Various elements and regions in the drawings are schematically illustrated; therefore, the present invention will not be construed by relative size or gap shown in the accompanying drawings.

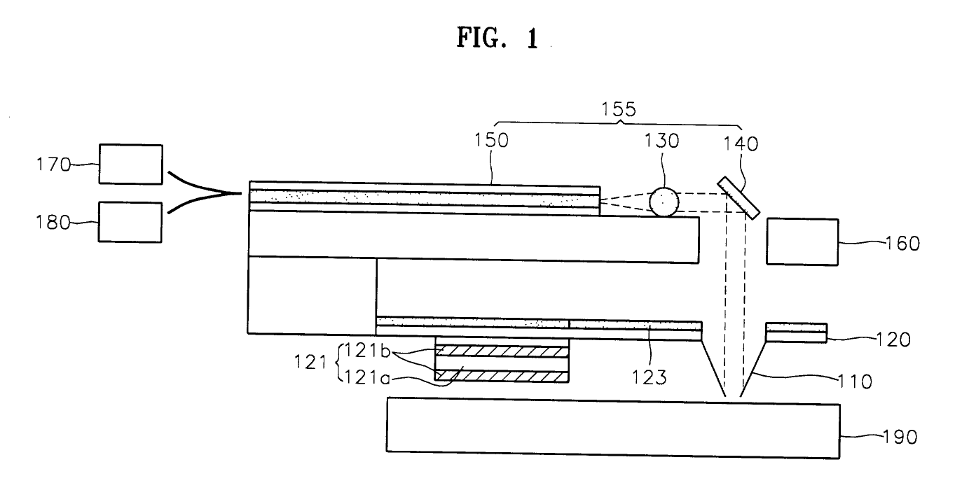

FIG. 1 is a side view of a micro-integrated near-field optical recording head according to an embodiment of the present invention. Referring to FIG. 1, a beam radiated from a laser diode 170 as a light source is input through an optical fiber 150 and focused on a microlens 130. The microlens 130 collimates the beam and a micro-mirror 140 changes the direction of the collimated beam by 90°. The beam may be directly focused at an aperture probe 110, or focused at the aperture probe 110 by passing through another microlens (not shown), which may be formed above the aperture probe 110. The microlens 130 is located on an optical axis of the optical fiber 150, which is arranged on a V-shape groove, to easily focus the beam. The micro-mirror 140 can be controlled to back and forth or tilted to precisely focus the beam at the aperture probe 110. In this case, the optical fiber 150, the microlens 130, and the micro-mirror 140 are referred to as a micro-optical unit 155. Unlike in the case of U.S. Pat. No. 5,517,280, the micro-optical unit 155 of the present invention is not formed on a cantilever 120, but on an optical waveguide body 160 above the cantilever 120. Accordingly, a integration process is conveniently performed.

The aperture probe 110 is formed at the cantilever 120 by a semiconductor processor and may be constituted in a pyramid structure. The size of the aperture probe 110 is designed to be 50 to 100 nm, which is smaller than the wavelength of the beam used in the preferred embodiment. Accordingly, a near-field beam of evanescent wave is generated at the end of the aperture probe 110. The near-field beam is radiated to a medium 190 to record information, or the beam reflected on the medium 190 is input to an optical detection photodiode 180 through the micro-optical unit 155 to read the information.

The aperture probe 110 may be formed by coating a self-focusing material, a high refractive index material, or a metal thin film formed of gold, silver, bronze, chrome, or aluminum for maximizing coupling to a surface plasmon, so as to maximize a near-field throughput. Such a film focuses a laser beam to improve near-field throughput efficiency. The film is formed by a sputtering method or a thermal evaporation method. The self-focusing material is a non-linear material, which is formed of calcogenide, such as antinomy (Sb), germanium (Ge), arsenic trisulphide (As₂S₃), indium antimonide (InSb), gallium arsenide (GaAs), zinc selenide (ZnSe), and AIP and semiconductor elements or an alloy of the same. In other case, the self-focusing material can be formed by mixing the above material in a particle state to a glass having silicon dioxide (SiO₂) as a matrix. The surface plasmon propagates to the end of the aperture probe 110 to maximize efficiency at the end of the aperture probe 110.

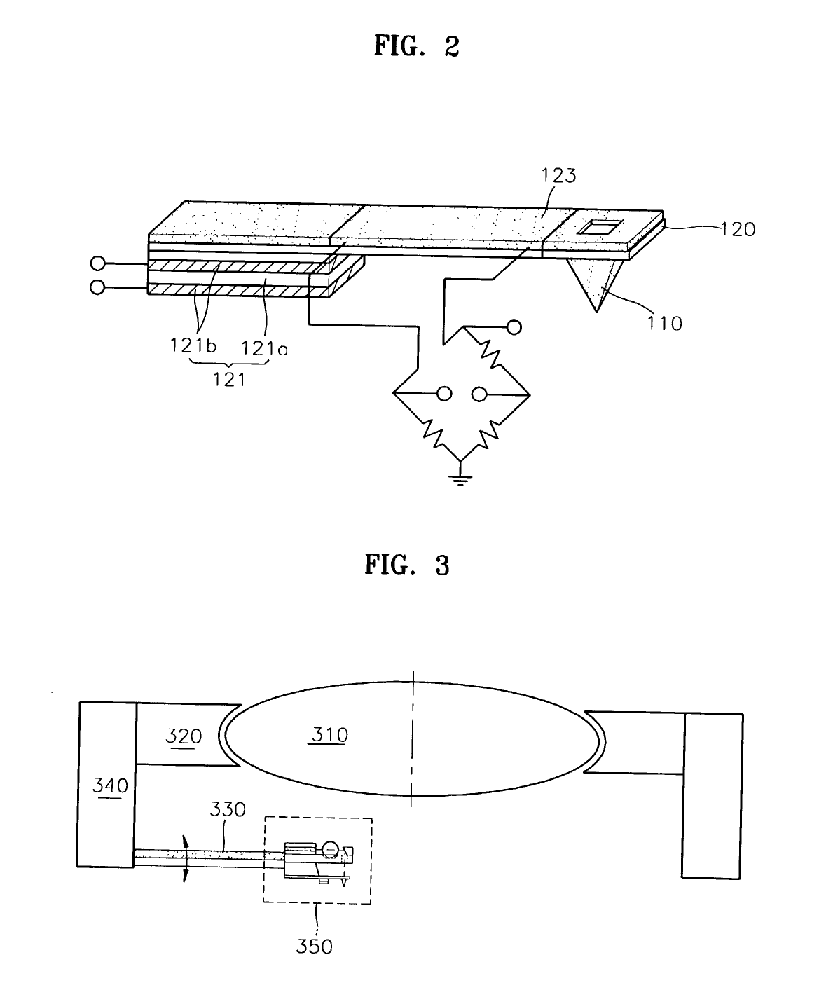

FIG. 2 is an enlarged perspective view of the cantilever 120 portion included in the head shown in FIG. 1. The cantilever 120 formed of silicon is manufactured by the semiconductor process method. As shown in FIG. 2, a piezoelectric actuator 121, which is formed of electrodes 121b with a ferroelectric thin film 121a, such as a lead zirconate titanate (PZT), therebetween, is formed under the cantilever 120 to vibrate the cantilever 120 in a piezoelectric manner. A Van der Waals force between the aperture probe 110 and the medium 190 induces deflection in vibration and changes in resonance frequency. By detecting the deflection and change, a gap between the aperture probe 110 and the medium 190 is maintained within a range of tens of nanometers.

The vibration can be detected by a couple of photodiodes that detect the bend of the cantilever by using a laser, such as in a conventional non-contact atomic force microscopy (AFM) method. However, the method is complicated and increases the size of the NFR system. Accordingly, the vibration is preferably detected by a method using a piezoresistive layer 123 in which an electric conductivity is varied according to the curvature of the cantilever 120 by doping the upper surface of the cantilever 120 with boron, etc. Consequently, it is possible to record/readout the information having recording size of 50 to 100 nm by using the micro-integrated near-field optical recording head.

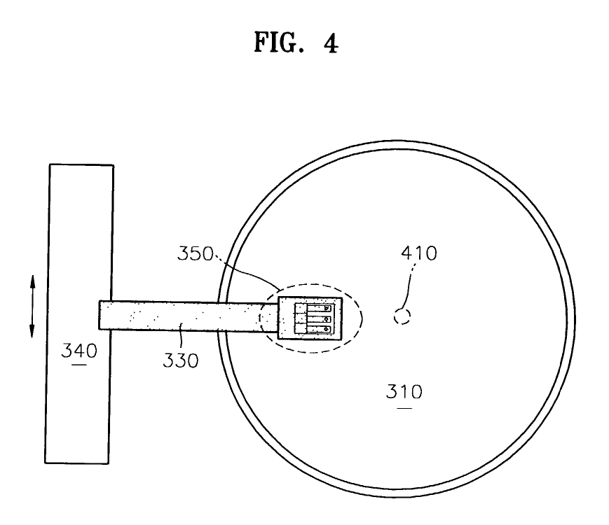

Referring to FIGS. 3 and 4, a second embodiment of the present invention will be described. In the second embodiment of the present invention, a multi-cantilever micro-integrated near-field optical recording head, which is formed by arranging one-dimensional array type micro-integrated near-field optical recording heads in a diameter direction of a medium, is used. Accordingly, a plurality of probes simultaneously record/readout information on/from a plurality of tracks. For convenience, a multi-cantilever micro-integrated near-field optical recording head 350, which is formed by arranging the micro-integrated near-field optical recording heads of FIGS. 1 and 2 in a diameter direction of a medium, is illustrated in FIGS. 3 and 4. In this case, the micro-integrated near-field optical recording heads are manufactured in a one-dimensional array manner. FIG. 3 is a side view of an optical recording system using the multi-cantilever micro-integrated near-field optical recording head 350, and FIG. 4 is a plan view of the optical recording system shown in FIG. 3.

Referring to FIGS. 3 and 4, the multi-cantilever micro-integrated near-field optical recording head 350 is coupled with a bimorph type Z-axis fine vertical actuator 330. The Z-axis fine vertical actuator 330 is connected to an XY-axis fine horizontal actuator 340 of fine tracking, which can be driven in a horizontal direction, to be coupled below an objective lens 310 of an optical disk via an objective lens holder 320. In the cases of recording/reading-out information, a beam focused in the objective lens 310 coarsely approaches the medium by a voice coil motor (VCM) (not shown), which moves the lens. Moreover, the beam finely approaches the surface of the medium by gap controllers 121 and 123 (refer to FIGS. 1 and 2) included in the multi-cantilever micro-integrated near-field optical recording head 350, which detect an atomic force between the aperture probe and the medium. In this case, the Z-axis fine vertical actuator 330 is also used. The beam focused in the objective lens 310 is focused in the land-groove structure of the medium so that a gap between the objective lens 310 and the medium maintains an error rate of 1 μm.

More specifically, the gap between the aperture probe under the objective lens 310 and the surface of the medium is adjusted by bending the Z-axis fine vertical actuator 330. A maximum deflection of the Z-axis fine vertical actuator 330 is tens of micrometers to maintain the gap between the aperture probe and the medium surface with the error rate of 1 μm. The piezoelectric actuator 121 not only vibrates the cantilever 120 in a vertical direction, but also detects a force applied to the aperture probe, via the piezoresistive film 123 when the aperture probe approaches the medium surface. Therefore, the piezoelectric actuator 121 bends the cantilever 120 to maintain a gap with a precision rate of nm degree. According to the approach in a triple mode, a rapid and stable connection is possible. When the aperture probe has approached the medium, the only requirement is to maintain a constant gap between the aperture probe and the medium within several nanometers. Consequently, the VCM of moving the objective lens 310 and the gap controllers 121 and 123 of the cantilever control the gap according to the vertical vibration of the medium and the fine shape on the medium surface. A reference numeral 410 denotes an optical spot on the medium.

Since the beam focused in the objective lens 310 is focused on an information recording layer of the medium, it is possible to track information recording lines on the disk type medium by using a groove structure. In the case of using a visible light like in a conventional method, a limit for a width between grooves is 400 nm, so that it is impossible to precisely track the information recording bits of 50 to 100 nm.

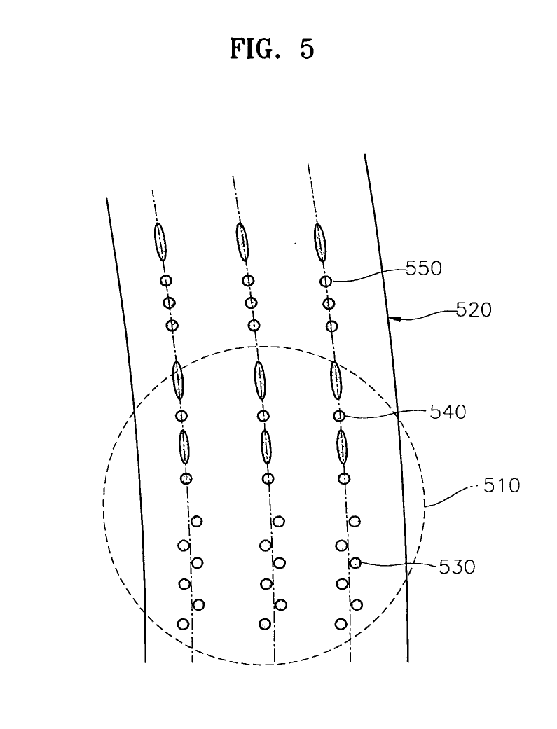

Accordingly, a coarse tracking technology and a fine tracking technology are used as shown in FIG. 5. In the coarse tracking technology, three to six tracks are introduced to a groove structure 520 to track diffractive signals reflected from an optical spot 510, which is focused via the upper objective lens, by six photodiodes that follow the diffractive signals. Accordingly, the six photodiodes track each groove track, in the coarse tracking technology. In the case of the fine tracking technology, address marks 540 and recording bits 550, which follow multi-track lines 530 arranged on the recording layer in zigzag type, are read by side actuation of the gap controllers of the cantilever.

Another fine tracking method is suggested by Nakamura et al. (Jpn.J. Appl. Phys., Vol. 37, 2271 (1998)). Here, optical signals about track location detected by three couples of photo detectors, which are connected to an objective lens, are calculated by a circuit method to obtain a track error signal, so that information can be recorded/readout on/from several tracks within one groove. However, in the case of recording/reading-out information by using a multi-cantilever, it is difficult to perform a precise tracking in a plurality of tracks for multi-probe by tilt on the plane of a cantilever. Therefore, a side fine actuation mechanism by using an additional horizontal actuator, such as the XY-axis fine horizontrol actuator 340, has to be accompanied.

The above-described micro-integrated near-field optical recording head can minimize damage on the aperture probe and the medium by finely adjusting the gap between the cantilever of non-contact-AFM type and the medium.

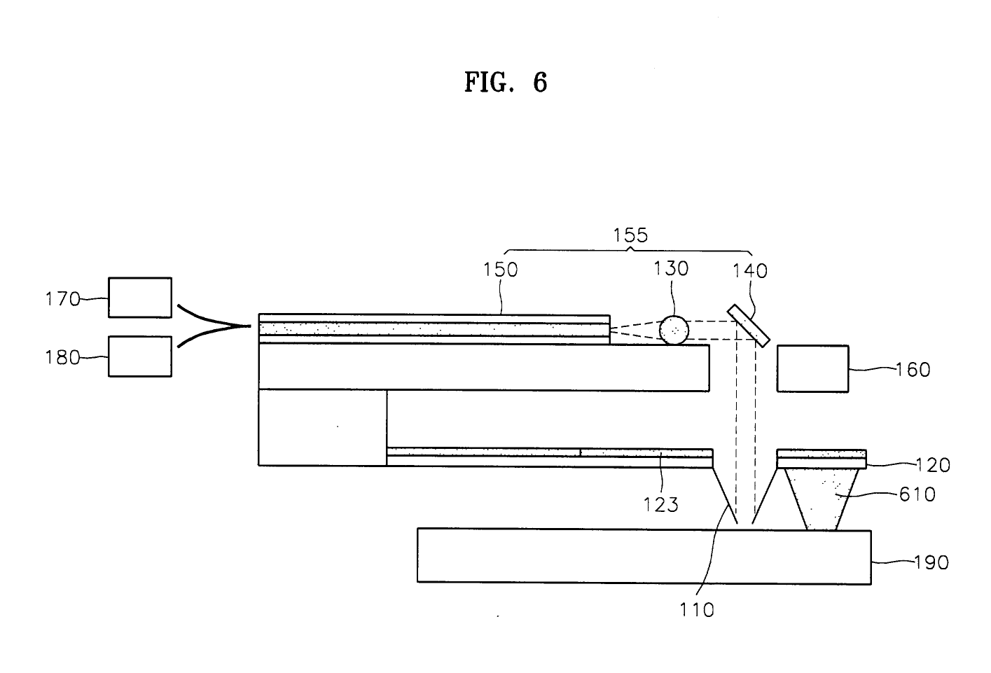

FIG. 6 is a side view of a micro-integrated near-field optical recording head according to a third embodiment of the present invention. In the third embodiment of the present invention, a gap control type head that uses a cantilever of contact-AFM type is used. In this case, structures of a micro-optical unit 155 and an aperture probe 110 are similar to the structures of those in the non-contact-AFM method shown in FIGS. 1 and 2. In the third embodiment of the present invention, a contact probe 610 formed under a cantilever 120 in an outer direction of the aperture probe 110 forcibly control a gap between the aperture probe 110 and a medium 190. The dull-shaped bottom of a contact probe 610 contacts with the medium 190 to constantly maintain a gap between the aperture probe 110 and the medium 190. The aperture probe 110 and the medium 190 maintain a gap for tens of nanometers while not directly contacting each other, thereby minimizing damage. A force between the contact probe 610 and the medium 190 is measured by a piezoresistive film 123 on the cantilever 120, which detects the bending of the cantilever 120. In order to maintain the force, actuation/control systems, such as a VCM and a bimorph type Z-axis fine vertical actuator of FIGS. 3 and 4 are operated. In comparing to the above-described non-contact-AFM method, a head shown in FIG. 6 does not require to install a piezoelectric actuator in the cantilever 120. Accordingly, process and control are simplified, and the aperture probe 110 is completely protected. In addition, the head of FIG. 6 can record/readout information while scanning on the medium at an indefinite speed, theoretically, which is different from the non-contact-AFM method in which the recording/readout speeds of the single probe are limited by the natural frequency of the cantilever. In this case, the planar tracking technology for reading/writing data on the medium by using the non-contact-AFM head described with reference to FIG. 5 can be used to read/write data on the medium by using the contact-AFM head according to the third embodiment of the present invention.

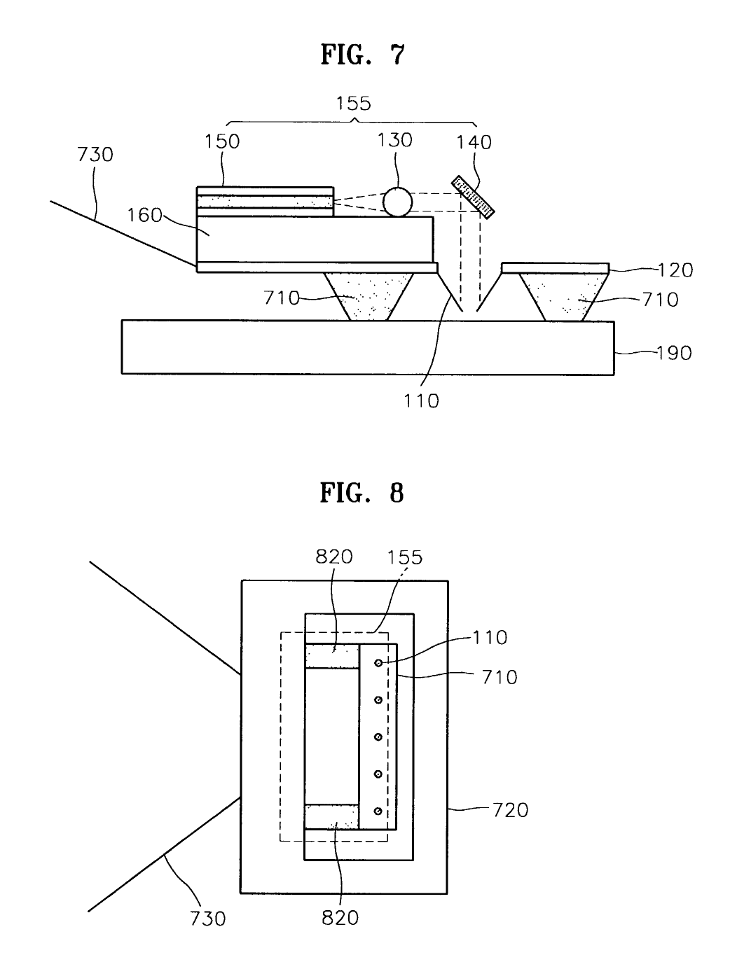

FIG. 7 is a side view of a contact slider micro-integrated near-field optical recording head according to a fourth embodiment of the present invention, and FIG. 8 is a view for explaining a tracking principle using tilt of the head shown in FIG. 7. The fourth embodiment illustrates another method for controlling a gap between an aperture probe and a medium, which is different from a method in which a micro-integrated optical head measures and maintains a gap and force between a head and a medium.

Referring to FIG. 7, a gap is forcibly controlled by contacting suspension sliding pads 710 around an aperture probe 110 with a medium 190 like in a hard disk. In this case, a cantilever 120 is attached to the suspension sliding pads 710, which forcibly contact with the medium 190 by a flexible suspension supporter 730 like in a hard disk head. According to the fourth embodiment of the present invention, the actuation/control structure of the head is simplified and a scanning speed is improved by not requiring a piezoelectric actuator and a piezoresistive film in the cantilever 120. However, the slide suspension supporter 730 generates a strong and fluctuating friction, thereby causing mechanical abrasion and heat at contact portions. However, since recording density is high and a multi-process of one-dimensional multi-array type is possible in an NFR probe type head, the scanning speed is low at about tens of cm/sec, so that the problems, such as abrasion and heat, are not much serious than in a conventional optical disk drive (ODD). Referring to FIG. 7, the suspension sliding pads 710 are adjacent to the aperture probe 110 to prevent damage on the aperture probe 110 in recording/readout information.

In the case of a contact suspension method, it is difficult for a multi-array type aperture probe to precisely track information regions. In order to precisely track the information regions, an actuation control technology for side tilt of a sliding head of FIG. 8 is required, as well as a precise actuation in horizontal diameter direction. As shown in FIG. 3, after recording zigzag type tracking lines and inputting addresses and information, diameter direction and tilt of a multi-probe are adjusted to precisely access the tracking lines in reading the information, then the multi-probe reads the information that follow the tracking lines. Accordingly, a horizontal actuator 820 for controlling tilt has to be manufactured in the head, as well as a fine actuator for controlling the sliding head in a diameter direction, along with a micro-optical unit 155. A reference numeral 720 denotes a suspension body.

With reference to FIGS. 1 through 8, the entire structure of an optical recording apparatus, i.e., an optical recording system having a micro-integrated near-field optical head according to the present invention will now be described. An integrated optical head approaches a rotation disk type medium to access information. Here, in order to precisely control an access location, a conventional VCM of controlling an optical disk head and a coarse/fine dual mode actuator control an objective lens and a near-field head under the objective lens. The location of a head 350 having one-dimensional multi-array aperture probes in a diameter direction is finely controlled by a Z-axis fine vertical actuator 330 and an XY-axis fine horizontal actuator 340 attached to an objective lens 310, and a piezoelectric actuator 121 in a cantilever. Moreover, the head, the Z-axis fine vertical actuator 330, and the XY-axis fine horizontal actuator 340 are attached to the objective lens 310 of a CD at an upper portion, thereby possibly using a conventional technology of tracking optical disks. In the case that a gap between the near-field optical head and the medium is controlled in a contact-AFM manner by using a contact probe 610, the piezoelectric actuator in the cantilever is not required. Instead, a gap control technology, which maintains a force between the contact probe 610 and the medium by using the displacement of a piezoresistive film 123, is used to maintain friction.

In the case that the gap between the near-field optical head and the medium is controlled by contact suspension sliding pads 710, the objective lens and the cantilever structure are not required. Instead, a head portion formed of an optical introduction unit, a detection unit, a high transmittance aperture probe, and a contact pad contacts to the medium by the pressure of a flexible suspension supporter 730 while tilt controlled by a fine horizontal actuator 820. Since the above-described embodiments use the one-dimensional multi-array type aperture probe head, a signal multi-processing technology and a tracking technology, such as tilt control for simultaneously connecting to multi-tracks, are required.

As shown in the preferred embodiments of the present invention, optical information can be recorded/readout at a high speed by using one-dimensional aperture probe type near-field heads and a disk type actuator. In the case of an MEMS type XY-raster scanner method, a scan region is very small, a manufacturing process is complicated, and it is difficult to be controlled. On the other hand, the disk type actuator is conveniently manufactured and attained due to being practically used as an information recorder. Since an aperture probe and an optical unit thereof integrated in a microstructure are used, it is possible to apply a multi-probe head to overcome a limit in recording/readout speed of the conventional near-field optical probe. In the case of using an aperture probe of 50 nm, a recording density can be hundreds of Gbit/in². In the case of using a single aperture probe of 50 nm, recording/readout speed can be 0.1 to 1 Mbps. In the case of using a multi-probe head having 10 aperture probes of 50 nm, the recording/readout speed can be 10 Mbps. Accordingly, the limit in information storage capacity can be overcome.

While this invention has been particularly shown and described with reference to preferred embodiments thereof, the preferred embodiments described above are merely illustrative and are not intended to limit the scope of the invention. It will be understood by those skilled in the art that various changes in form and details may be made therein without departing from the spirit and scope of the invention as defined by the appended claims.

What is claimed is:

1. A micro-integrated near-field optical recording head comprising:
a micro-optical unit including an optical waveguide, a microlens, and a micro-mirror;
a cantilever installed under the micro-optical unit;
an aperture probe having a size of less than 100 nm, which is formed on the bottom of the cantilever in a protruding manner; and
a gap control structure for maintaining a gap between the aperture probe and a medium for a beam input through the micro-optical unit to record/readout information on/from the medium by using a near-field beam having a resolution of less than 100 nm while passing through the aperture probe.

2. The micro-integrated near-field optical recording head of claim 1, wherein the size of the aperture probe is 50 to 100 nm.

3. The micro-integrated near-field optical recording head of claim 1, wherein the gap control structure uses a principle of detecting changes in a frequency or a vibration deflection by atomic force between the aperture probe and the medium when a self-vibration between the aperture probe and the medium is induced.

4. The micro-integrated near-field optical recording head of claim 3, wherein the gap control structure includes:
a piezoelectric actuator formed on the bottom of the cantilever while including a ferroelectric thin film for vibrating the cantilever; and
a piezoresistive thin film formed on the top surface of the cantilever to detect the changes in the frequency or the vibration deflection by detecting a potential induced from the vibration of the cantilever.

5. The micro-integrated near-field optical recording head of claim 1, wherein the gap control structure includes:
a contact probe formed on the bottom of the cantilever toward the outside of the aperture probe; and
a piezoresistive thin film formed on the top surface of the cantilever to maintain a gap between the aperture probe and the medium by detecting contact force between the medium and aperture probe, thereby forcibly controlling the gap between the aperture probe and the medium.

6. The micro-integrated near-field optical recording head of claim 1, wherein the gap control structure is contact suspension sliding pads formed on the bottom of the cantilever toward the outside of the aperture probe, thereby forcibly controlling the gap between the aperture and the medium.

7. The micro-integrated near-field optical recording head of claim 1, wherein the aperture probe is in a pyramid structure formed by a semiconductor process.

8. The micro-integrated near-field optical recording head of claim 7, wherein the inside of the aperture probe to which the beam is input, is coated by a self-focusing material, a high refractive index material, or a metal thin film for maximizing coupling with a surface plasmon, in order to maximize a near-field throughput.

9. The micro-integrated near-field optical recording head of claim 1, wherein the beam radiated from an optical waveguide is focused through the microlens, and the micro-mirror changes the direction of the beam by 90° to input to the aperture probe.

10. A micro-integrated near-field optical recording head comprising the micro-integrated near-field optical recording heads of claim 1 manufactured in a one-dimensional array type, which are arranged in a diameter direction of a medium, so as to realize a structure in which a plurality of probes simultaneously record/readout information on/from a plurality of tracks.

11. A micro-integrated near-field optical recording system comprising:
the micro-integrated near-field optical recording head of claim 10;
a bimorph type Z-axis fine vertical actuator coupled with the head;
an XY-axis fine horizontal actuator of fine tracking coupled with the bimorph type actuator; and
an objective lens of an optical disk connected to the XY-axis fine horizontal actuator of fine tracking by a holder,
wherein a beam focused on the objective lens coarsely approaches a medium by a voice coil motor (VCM) that moves the objective lens, and the head finely approaches the surface of the medium by the bimorph type actuator and the gap control structure.

12. The micro-integrated near-field optical recording system of claim 11, further divides one groove into tracks while tracking between the grooves through the objective lens to record/readout information while tilt controlled by the gap control structure.

13. The micro-integrated near-field optical recording system of claim 11, wherein horizontal or vertical locations of the objective lens and the aperture probe are controlled at a resolution of several nm by the bimorph type Z-axis fine vertical actuator and the XY-axis fine horizontal actuator of fine tracking, along with the gap control structure.

14. The micro-integrated near-field optical recording system of claim 11, wherein the gap control structure includes:
a piezoelectric actuator formed on the bottom of the cantilever to include a ferroelectric thin film for vibrating the cantilever; and
a piezoresistive thin film formed on the top surface of the cantilever to detect a changes in a frequency or a vibration deflection by detecting a potential induced from the vibration of the cantilever.

15. The micro-integrated near-field optical recording system of claim 11, wherein the gap control structure includes;
a contact probe formed on the bottom of the cantilever toward the outside of the aperture probe; and
a piezoresistive thin film formed on the top surface of the cantilever to maintain a gap between the aperture probe and a medium by detecting a contact force between the medium and the aperture probe, thereby forcibly controlling the gap between the aperture probe and the medium.

16. A micro-integrated near-field optical recording system for realizing a structure in which a plurality of probes simultaneously record/readout information on/from a plurality of tracks, the system comprising:
a micro-integrated near-field optical recording head having the micro-integrated near-field optical recording heads of claim 6, which are manufactured in a one-dimensional array manner and arranged in a diameter direction of a medium;
a flexible suspension supporter of applying pressure for the head to contact with the medium; and
horizontal and vertical fine actuators for controlling horizontal location and tilt of the head.
